(19) United States
(12) Patent Application Publication
(10) Pub. No.: US 2010/0279709 A1
(43) Pub. Date: Nov. 4, 2010

(54) ULTIMODE SUPPORT IN WIRELESS COMMUNICATIONS

(75) Inventors: Reza Shahidi, San Diego, CA (US); Sanjeev A. Athalye, San Diego, CA (US); Jeremy H. Lin, San Diego, CA (US); Victor A. Abramsky, Southampton, PA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/432,355

(22) Filed: Apr. 29, 2009

(51) Int. Cl. H04W 24/00; H04M 1/00

(52) U.S. Cl. 455/456.2; 455/550.1

(57) ABSTRACT

Systems and methodologies are described that facilitate multimode communication in wireless networks. Receiving and/or transmitting components can comprise a plurality of receive paths over which antennas can forward concurrently received signals to facilitate simultaneous or shared receiving of signals related to disparate communication technologies. The receive paths can be implemented by one or more multiplexers (e.g., diplexers, triplexers, etc.) to facilitate separating signals simultaneously received over disparate bands. In addition, antenna switching is described to facilitate shared receiving. Multimode transmitting is similarly provided. In particular, voice, data and global positioning system (GPS) signals can be concurrently received and processed by a wireless device.

### BACKGROUND

I. Field

The following description relates generally to wireless communications, and more particularly to simultaneous or shared support of multiple communication modes.

II. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), 1× radio transmission technology (1×RTT or 1×), one or more revisions thereof, etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations. Wireless communications devices can support communications for multiple technology types. This is typically accomplished by utilizing antennas for each technology along with an associated receiver. In addition, many wireless communications devices support global positioning system (GPS) communication for location determination and/or other functionalities.

### SUMMARY

The following presents a simplified summary of one or more embodiments in-order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating simultaneous and/or shared multimode communication support in wireless networks. For example, mobile devices can communicate using multiple technologies either simultaneously or by sharing resources. In addition, the mobile device can support diversity combining connected, idle, and/or access states related to the technologies. The supported technologies, as described herein, can be one or more of third generation partnership project (3GPP) long term evolution (LTE), ultra mobile broadband (UMB), evolution data optimized (EV-DO), 1× radio transmission technology (1×), global positioning system (GPS) and/or the like. Multiple antennas and/or receiver/transmitters can be provided to facilitate the multimode communication, and various combinations of antenna and receiver/transmitter configurations are described herein.

According to related aspects, a method for supporting multimode communication in wireless networks is provided. The method includes concurrently receiving a plurality of signals from one or more wireless devices, wherein each signal in the plurality of signals is of a disparate communication technology including a voice, a data or a GPS technology. The method further includes determining the communication technology related to each signal in the plurality of signals and interpreting each signal in the plurality of signals to facilitate multimode communication.

Another aspect relates to a wireless communications apparatus. The wireless communications apparatus can include at least one processor configured to determine a plurality communication technologies related to a plurality of concurrently received signals, wherein the plurality of communication technologies relate to voice, broadband data, or GPS. The processor is further configured to interpret the plurality of signals according to the determined communications technologies to facilitate multimode communication. The wireless communications apparatus also comprises a memory coupled to the at least one processor.

Yet another aspect relates to a wireless communications apparatus that facilitates multimode communication in wireless networks. The wireless communications apparatus can comprise means for concurrently receiving wireless signals of disparate communication technology types, wherein the disparate communication technology types include voice, data, or GPS types. The wireless communications apparatus can additionally include means for determining a communication technology type for each of the concurrently received wireless signals and means for interpreting at least one of the concurrently received wireless signals according to its determined communication technology type to facilitate multimode communication.

Still another aspect relates to a computer program product, which can have a computer-readable medium including code for causing at least one computer to concurrently receive a plurality of signals from one or more wireless devices, wherein each signal in the plurality of signals is of a disparate communication technology including a voice, a data or a GPS technology. The computer-readable medium can also comprise code for causing the at least one computer to determine the communication technology related to each signal in the plurality of signals and code for causing the at least one computer to interpret each signal in the plurality of signals to facilitate multimode communication.

Moreover, an additional aspect relates to an apparatus. The apparatus can include a plurality of antennas that concurrently receive wireless signals of disparate communication technology types, wherein the disparate technology types include voice, data, or GPS types. The apparatus can further include a receiver/transmitter component that determines a communication technology type for each of the concurrently received wireless signals and a multimode communication component that interprets at least one of the concurrently received wireless signals according to its determined communication technology type to facilitate multimode communication.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example device for concurrently receiving/transmitting signals of disparate communication technology types.

FIGS. 3-8 are illustrations of example receiver/transmitter configurations to facilitate multimode communication.

FIGS. 9-10 are illustrations of example antenna configurations to facilitate concurrently receiving signals of disparate technology types.

FIG. 11 is an illustration of an example methodology that facilitates multimode communication in wireless networks.

FIG. 12 is an illustration of an example mobile device that concurrently communicates in multiple modes.

FIG. 13 is an illustration of an example wireless network environment that can be employed in conjunction with the various systems and methods described herein.

FIG. 14 is an illustration of an example system that facilitates concurrent multimode communication.

### DETAILED DESCRIPTION

Various embodiments are now described with reference to the drawings, wherein like reference numerals are used to refer to like elements throughout. In the following description, for purposes of explanation, numerous specific details are set forth in-order to provide a thorough understanding of one or more embodiments. It may be evident, however, that such embodiment(s) can be practiced without these specific details. In other instances, well-known structures and devices are shown in block diagram form in-order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000 (e.g., 1×, 1× radio transmission technology (1×RTT), etc.), IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). The techniques described herein can also be utilized in evolution data optimized (EV-DO) standards, such as 1xEV-DO revision B or other revisions, and/or the like. Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

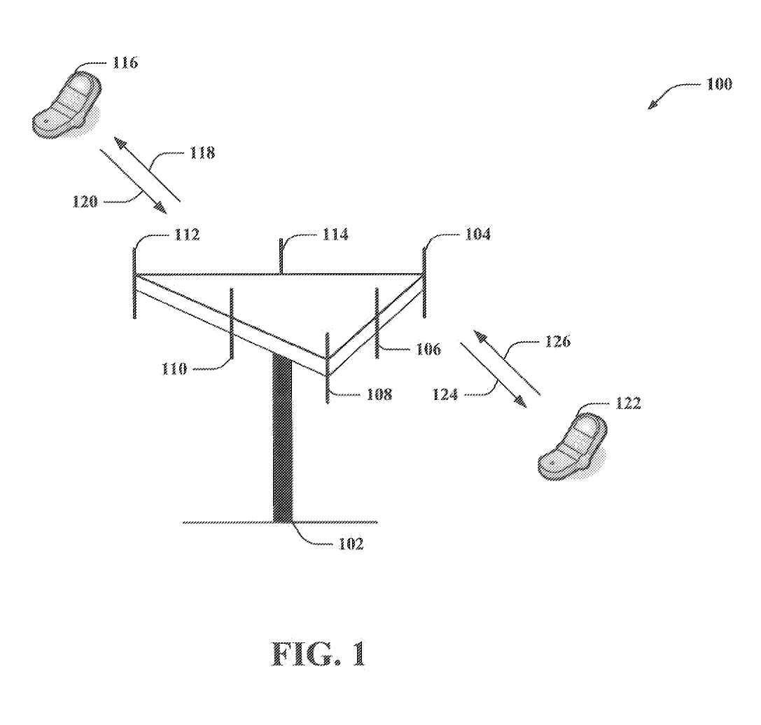

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology (not shown).

According to an example, system 100 can support multimode wireless communications such that the base station 102 and/or mobile devices 116 and/or 122 can communicate using a plurality of technologies. In one example, the mobile devices 116 and/or 122 can receive communications from the base station 102 and one or more disparate devices (not shown) where the base station 102 and the one or more disparate devices communicate using disparate technologies. Mobile devices 116 and/or 122, in this regard, can implement simultaneous or shared receiving to communicate concurrently with the base station 102 and one or more disparate devices. Simultaneous receiving relates to tuning respective receivers to receive communications for different technologies at the same time; this can be over a single antenna and can be implemented using diplexers, triplexers, etc. to demultiplex the received signal. Shared receiving relates to tuning a receiver to receive communications for one or another technology at a given point in time; this can be accomplished, for example, by antenna switching, as described herein. Mobile devices 116 and/or 122 can comprise multiple antennas and receiver/transmitter structures to facilitate such multimode communications.

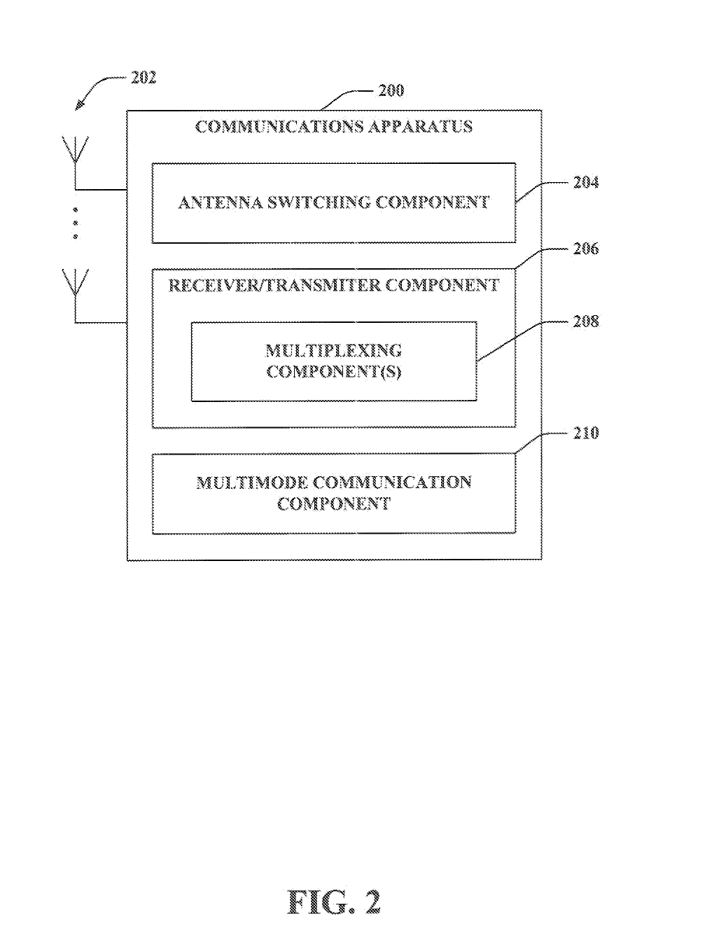

Turning to FIG. 2, illustrated is a communications apparatus 200 for employment within a wireless communications environment. The communications apparatus 200 can be a base station or a portion thereof, a mobile device or a portion thereof, or substantially any communications apparatus that receives data transmitted in a wireless communications environment. The communications apparatus 200 can include a plurality of antennas 202 for concurrently receiving signals related to disparate communication technologies and an antenna switching component 204 that can switch the plurality of antennas 202 to implement shared receiving for the signals. Communications apparatus 200 can also include a receiver/transmitter component 206 that processes signals received over the antennas 202. The receiver/transmitter component 206 can further comprise one or more multiplexing components 208 that can facilitate simultaneously receiving a plurality of signals related to disparate communication technologies over a single antenna in the multiple antennas 202. In addition, the communications apparatus 200 can include a multimode communication component 210 that can interpret data received in the signals according to a determined communication technology.

According to an example, the communications apparatus 200 can comprise various combinations of antenna switches in antenna switching component 204 and multiplexing component(s) 208 to process signals received concurrently over the antennas 202. In one example, the communications apparatus 200 can include no antenna switching component 204 and/or no multiplexing components 208 within the receiver/transmitter component 206 as well. Architecture of the communications apparatus 200 can be based at least in part on cost, for instance. In one example, the communications apparatus 200 can comprise an antenna 202 for concurrently receiving each supported technology, in which case no antenna switching component 204 or multiplexing components 208 are necessary to facilitate concurrent receipt of the signals. In another example, however, an antenna switching component 204 and/or multiplexing components 208 facilitate utilizing a single antenna to concurrently receive signals from a plurality of disparate technologies. For example, antenna switching component 204 can allow receipt of signals during different time intervals, for which receiver/transmitter component 206 can forward signals to the multimode communication component 210 based on which switch was active when the signal was received. Multiplexing components 208, however, can be utilized to implement simultaneous receiving such that they can split received signals (e.g., based on frequency) into respective technologies for forwarding to the multimode communication component 210. Simultaneous and/or shared receiving allows for multimode communication using a less number of antennas than supported technologies, which decreases cost and interference, for example. It is to be appreciated that the antenna switching component 204 can be implemented within the receiver/transmitter component 206 as well, in one example.

In one example, as described herein, the communications apparatus 200 can comprise two antennas 202. The receiver/transmitter component 206 can support multiple communication technologies, such as 1×, DO, a data technology (e.g., LTE, UMB, UMTS, etc.), and GPS. In particular, the receiver/transmitter component 206 can facilitate concurrently transmitting and receiving using the technologies over the two antennas 202. In this regard, many configurations of the antenna switching component 204 and/or multiplexing components 208 are possible. In one configuration, a series of diplexers and/or triplexers can be provided as multiplexing components 208 to separate signals by frequency (e.g., demultiplex the signals). In this configuration, no antenna switching component 204 is necessary. In another configuration, however, an antenna switching component 204 can be additionally or alternatively provided for one or more of the antennas 202 to lower cost of implementing the receiver/transmitter component 206 as well as loss associated with receiving the signal.

In this regard, antenna switching component 204 can facilitate shared receiving, as described above, for a given antenna, and multiplexing components 208 can provide simultaneous receiving for a given antenna. In addition, having multiple antennas can also facilitate simultaneous receiving, and the antenna switching component 204 and/or multiplexing components 208 can be advantageously configured to allow simultaneous and/or shared receiving and/or transmitting of 1×, DO, data, and GPS along with diversity for one or more of the technologies in some cases. Example antenna and/or multiplexer configurations are described further herein. As the receiver/transmitter component 206 receives signals over the antennas 202, it can separate signals into respective technologies and provide them to the multimode communication component 210 for further processing. It is to be appreciated that signals can be concurrently transmitted and/or received over in-phase (I) and quadrature (Q) branches of the antennas 202 as well, in an example.

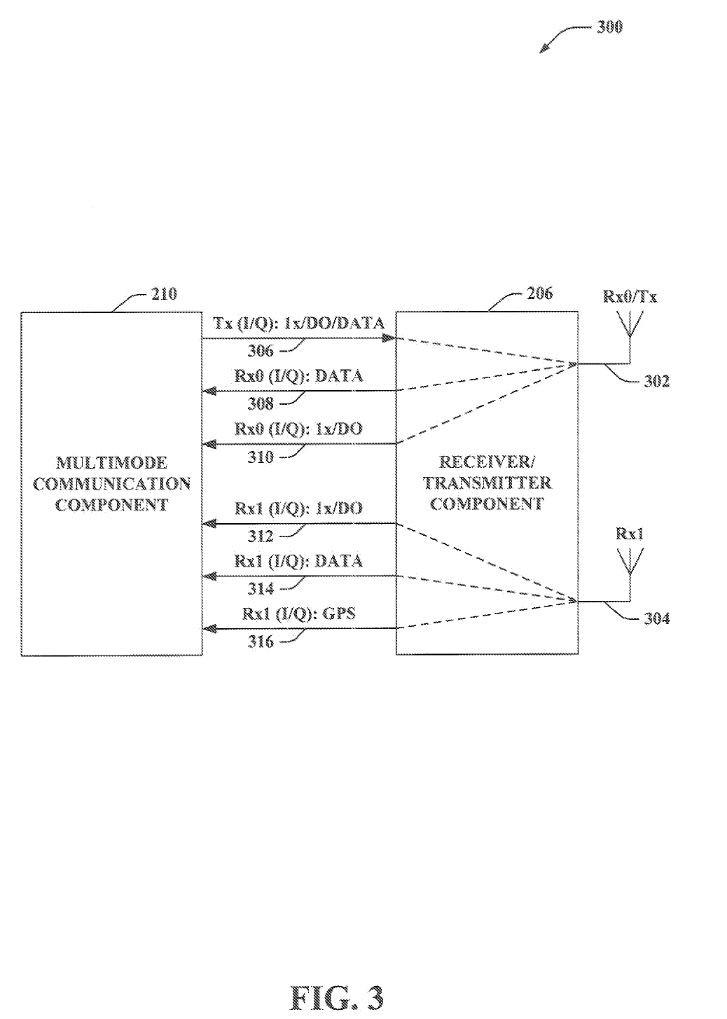

Referring now to FIG. 3, an example system 300 that supports simultaneously receiving signals related to disparate communication technologies in a wireless network is shown. The system 300 includes a receiver/transmitter component 206 that implements a plurality of receiving and transmitting paths to a multimode communication component 210. In addition, the system 300 includes a receive/transmit antenna 302 and another receive antenna 304 to facilitate concurrent communication, as described. As shown, the multimode communication component 210 can leverage the receiver/transmitter component 206 to transmit 1×, DO, and/or data (e.g., LTE, UMB, UMTS, etc.) over antenna 302 using transmit path 306. Sharing antenna 302 to transmit different technologies can be accomplished in a time domain such that each technology is scheduled to transmit in a different time period.

Additionally, five receive paths are shown between the multimode communication component 210 and receiver/transmitter component 206 to simultaneously receive signals of each of the disparate communication technologies. For example, a receive path 308 is shown for a data signal over antenna 302, where the data signal can be LTE, UMB, UMTS, and/or the like, as well as a receive path 310 for 1×/DO (or other cell data) over antenna 302. Thus, data and 1×/DO can be simultaneously received over the antenna 302 and separated by the receiver/transmitter component 206 (e.g., using a duplexer or other splitting device), for forwarding to the multimode communication component 210. Similarly, receive paths 312, 314, and 316 are shown for respectively receiving 1×/DO, data, and GPS signals simultaneously over antenna 304. The receiver/transmitter component 206 can separate the signals using a triplexer, in one example, or similar device, for forwarding to the multimode communication component 210. In this regard, there are many receiving/transmitting modes available in this configuration.

For example, 1×/DO can be transmitted and received over antenna 302 to facilitate active mode communication, as well as received over antenna 304 for diversity. Simultaneously, for example, data can be received over antenna 302 and/or antenna 304. Various multiplexing components in the receiver/transmitter components 206, as described, can separate the signals for forwarding to the multimode communication component 210. In another example, data can be transmitted and received over antenna 302 while 1×/DO is received over antenna 302 and/or 304 for diversity. Simultaneously, GPS can be received over antenna 304, as shown. Many other combinations are possible as well in this full simultaneous receiving configuration. It is to be appreciated that the receiver/transmitter component 206 can have a number of synthesizers to process the signals. In one example, the receiver/transmitter component 206 can have two synthesizers. Thus, to implement true simultaneous receiving of 1×/DO, data, and GPS on antenna 304, another processor (not shown) can be utilized to receive GPS signals and forward to the multimode communication component 210.

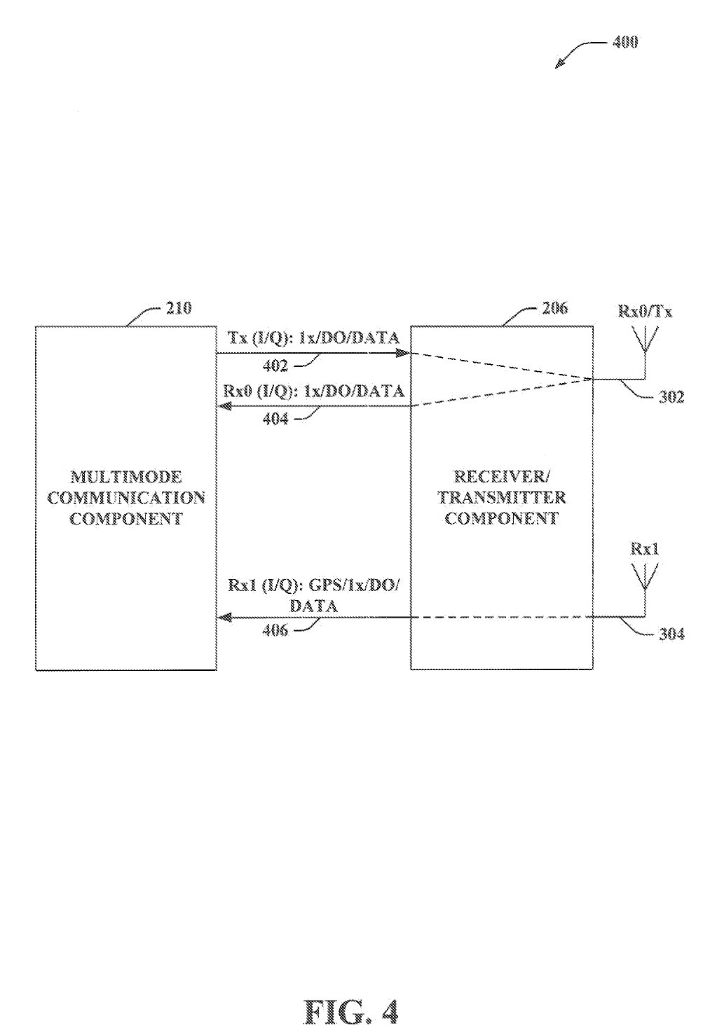

Now referring to FIG. 4, illustrated is an example system 400 that supports concurrently receiving signals related to disparate communication technologies in a wireless network using shared receiving. The system 400 includes a receiver/transmitter component 206 that generates a plurality of receiving and transmitting paths to a multimode communication component 210. In addition, the system 400 includes a receive/transmit antenna 302 and another receive antenna 304 to facilitate concurrent communication, as described. As shown, the multimode communication component 210 can leverage the receiver/transmitter component 206 to transmit 1×, DO, and/or data (e.g., LTE, UMB, UMTS, etc.) over antenna 302 using transmit path 402. Sharing antenna 302 to transmit different technologies can be accomplished in a time domain such that each technology is scheduled to transmit in a different time period, as described.

Additionally, two receive paths are shown between the multimode communication component 210 and receiver/transmitter component 206 to share receipt of signals related to each of the disparate communication technologies. For example, a receive path 404 is shown for a 1×/DO or data signal over antenna 302, where the data signal can be LTE, UMB, UMTS, and/or the like. Thus, data and 1×/DO can be concurrently received over the antenna 302 using sharing, which can be implemented by an antenna switch, in one example. The receiver/transmitter component 206 can operate the antenna switch over time to receive 1×/DO and data in different time periods. Thus, the receiver/transmitter component 206 can forward 1×/DO and/or data to the multimode communication component 210 according to the antenna switch. In addition, receipt of certain technologies can be prioritized over others. This can be based on a protocol, previous use, technology type of a related signal received over the other antenna 304, and/or the like, for example. Similarly, receive path 406 is shown for receiving 1×/DO, data, and GPS signals over antenna 304. The receiver/transmitter component 206 can similarly utilize an antenna switch to receive the signals at different time periods using the single receive path 406. As mentioned, the antenna structure can be implemented in a disparate component, for instance.

For example, 1×/DO can be transmitted and received over antenna 302 to facilitate active mode communication, as well as received over antenna 304 for diversity. Using a switch, for example, data can be received over antenna 302 and/or antenna 304. The receiver/transmitter component 206 can forward signals to the multimode communication component 210 based on the switch when the signal is received. In another example, data can be transmitted and received over antenna 302 while 1×/DO is received over antenna 302 (in a different time period), and/or 304 for diversity. Many other combinations are possible as well in this full shared receiving configuration.

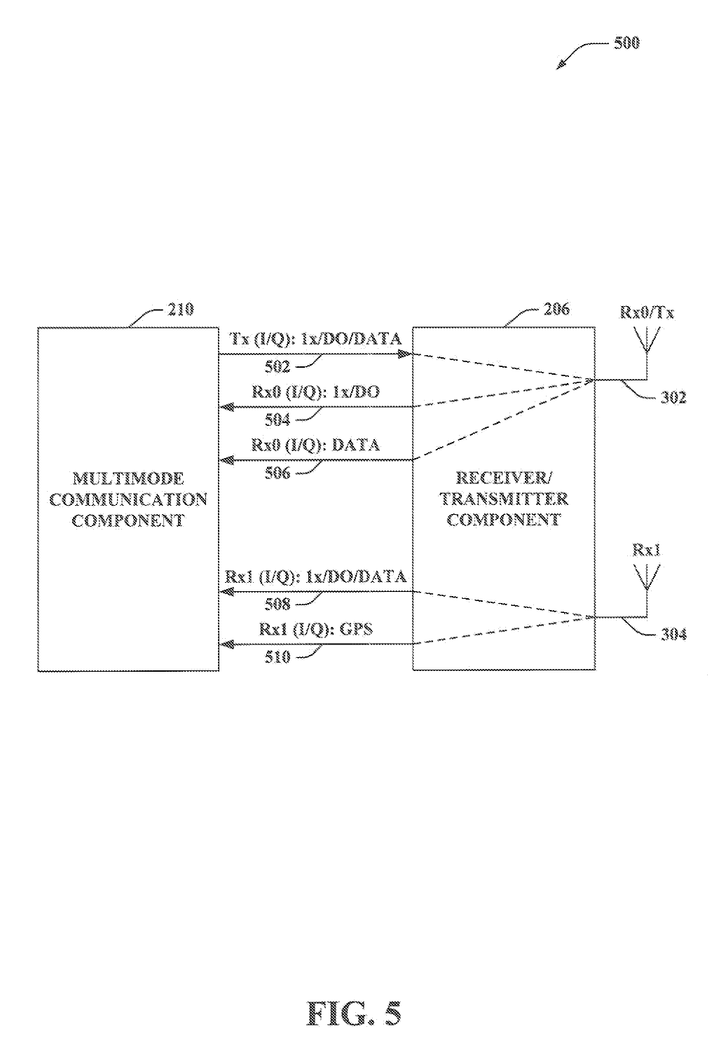

Turning to FIG. 5, an example system 500 that supports concurrently receiving signals related to disparate communication technologies in a wireless network using combined simultaneous and shared receiving is illustrated. The system 500 includes a receiver/transmitter component 206 that generates a plurality of receiving and transmitting paths to a multimode communication component 210. In addition, the system 500 includes a receive/transmit antenna 302 and another receive antenna 304 to facilitate concurrent communication, as described. As shown, the multimode communication component 210 can leverage the receiver/transmitter component 206 to transmit 1×, DO, and/or data (e.g., LTE, UMB, UMTS, etc.) over antenna 302 using transmit path 502. In one example, sharing antenna 302 to transmit different technologies can be accomplished in a time domain such that each technology is scheduled to transmit in a different time period.

Additionally, four receive paths are shown between the multimode communication component 210 and receiver/transmitter component 206 to facilitate simultaneous and/or shared receiving of signals related to each of the disparate communication technologies. For example, a receive path 504 is shown for a 1×/DO signal over antenna 302 as well as a receive path 506 for simultaneously receiving data over antenna 302. The data signal can be LTE, UMB, UMTS, and/or the like, for example. Thus, data and 1×/DO can be simultaneously received over the antenna 302, using one or more multiplexers for example, as described. Thus, the receiver/transmitter component 206 can forward 1×/DO and/or data to the multimode communication component 210 by separating the signals simultaneously received over antenna 302. Similarly, receive path 508 is shown for receiving 1×/DO and data over antenna 304. The receiver/transmitter component 206 can utilize an antenna switch, as described to implement shared receiving of the signals at different time periods using the single receive path 508. In addition, the receiver/transmitter component 206 can simultaneously receive GPS using receive path 510 over antenna 304, as described.

For example, the receiver/transmitter component 206 can transmit and receive 1×/DO over antenna 302 to facilitate active mode communication, as well as receive 1×/DO over antenna 304 for diversity. Data can be simultaneously received over antenna 302 and/or shared received over antenna 304 in a different time period. The receiver/transmitter component 206 can forward signals to the multimode communication component 210, as described. In another example, data can be transmitted and received over antenna 302 while 1×/DO is simultaneously received over antenna 302, or over antenna 304 using shared receiving, for diversity. Many other combinations are possible as well in this partial simultaneous/partial shared receiving configuration.

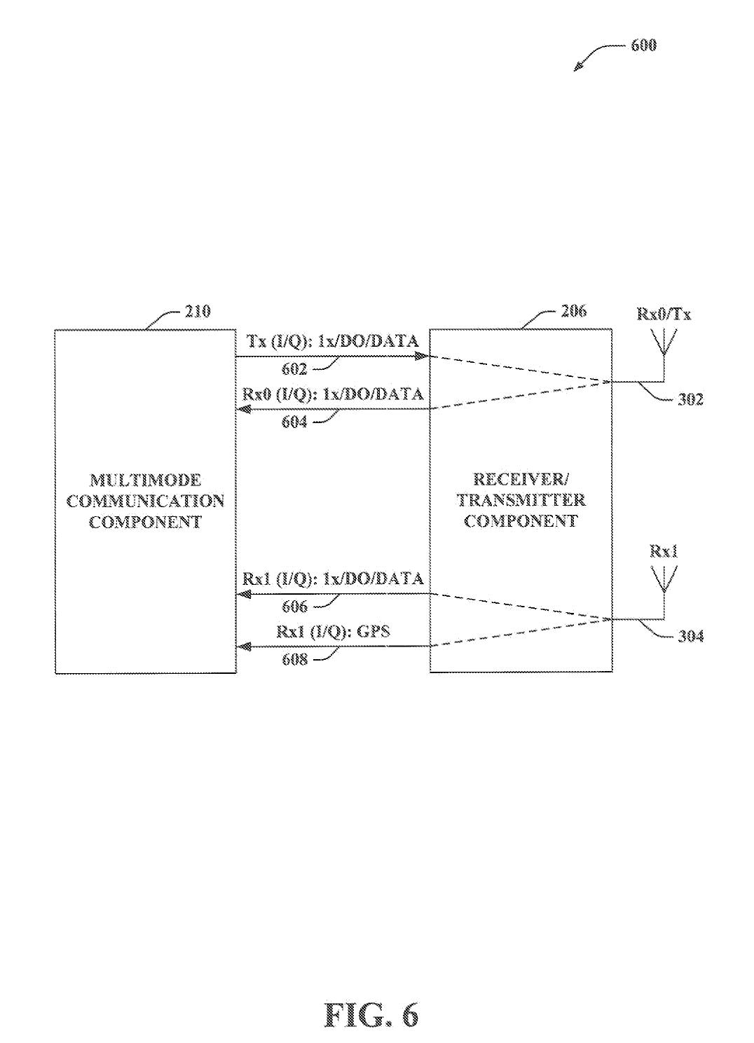

Referring now to FIG. 6, an example system 600 that supports concurrently receiving signals related to disparate communication technologies in a wireless network using shared receiving with simultaneous receiving for GPS is illustrated. The system 600 includes a receiver/transmitter component 206 that implements a plurality of receiving and transmitting paths to a multimode communication component 210. In addition, the system 600 includes a receive/transmit antenna 302 and another receive antenna 304 to facilitate concurrent communication, as described. As shown, the multimode communication component 210 can leverage the receiver/transmitter component 206 to transmit 1×, DO, and/or data (e.g., LTE, UMB, UMTS, etc.) over antenna 302 using transmit path 602. Sharing antenna 302 to transmit different technologies can be accomplished in a time domain such that each technology is scheduled to transmit in a different time period.

Additionally, three receive paths are shown between the multimode communication component 210 and receiver/transmitter component 206 to facilitate simultaneous and/or shared receiving of signals related to each of the disparate communication technologies. For example, a receive path 604 is shown for a 1×/DO or data signal over antenna 302. The data signal can be LTE, UMB, UMTS, and/or the like, for example. Thus, data and 1×/DO can be received over the antenna 302 using shared receiving (e.g., through antenna switching) for example, as described. In this regard, the receiver/transmitter component 206 can forward 1×/DO and/or data to the multimode communication component 210 according to which technology is currently being received by the antenna 302 (e.g., which switch is active). Similarly, receive path 606 is shown for receiving 1×/DO and data over antenna 304. The receiver/transmitter component 206 can utilize an antenna switch, as described to implement shared receiving of the signals at different time periods using the single receive path 606. In addition, the receiver/transmitter component 206 can simultaneously receive GPS over antenna 304, as described, via receive path 608.

For example, receiver/transmitter component 206 can transmit and receive 1×/DO over antenna 302 to facilitate active mode communication, as well as receive 1×/DO over antenna 304 for diversity. Data can be received over antenna 302 and/or 304 in a different time period using shared receiving. The receiver/transmitter component 206 can forward signals to the multimode communication component 210, as described, using the appropriate receive path. In another example, data can be transmitted and received over antenna 302 and/or 304 while GPS is simultaneously received over antenna 304 using receive path 608. Many other combinations are possible as well in this partial simultaneous/partial shared receiving configuration.

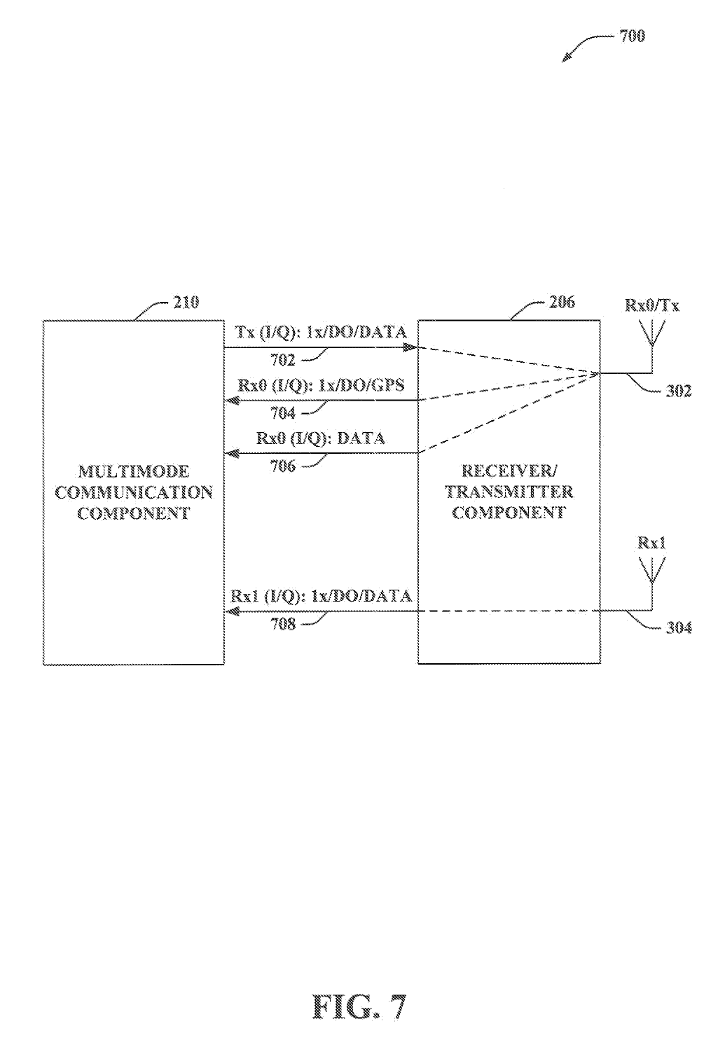

Turning to FIG. 7, an example system 700 that supports concurrently receiving signals related to disparate communication technologies in a wireless network using shared receiving with simultaneous receiving for GPS over a primary antenna is illustrated. The system 700 includes a receiver/transmitter component 206 that generates a plurality of receiving and transmitting paths to a multimode communication component 210. In addition, the system 700 includes a receive/transmit antenna 302 and another receive antenna 304 to facilitate concurrent communication, as described. As shown, the multimode communication component 210 can leverage the receiver/transmitter component 206 to transmit 1×, DO, and/or data (e.g., LTE, UMB, UMTS, etc.) over antenna 302 using transmit path 702. Sharing antenna 302 to transmit different technologies can be accomplished in a time domain such that each technology is scheduled to transmit in a different time period, as described.

Additionally, three receive paths are shown between the multimode communication component 210 and receiver/transmitter component 206 to facilitate simultaneous and/or shared receiving of signals related to each of the disparate communication technologies. For example, a receive path 704 is shown for a 1×/DO or GPS signal over antenna 302. Thus, GPS and 1×/DO can be received over the antenna 302 using shared receiving (e.g., through antenna switching) for example, as described. Thus, the receiver/transmitter component 206 can forward 1×/DO and/or GPS to the multimode communication component 210 according to which technology is currently being received by the antenna 302. Similarly, receive path 706 is shown for simultaneously receiving a data signal over antenna 302 as well. The data signal can be LTE, UMB, UMTS, and/or the like, for example. In addition, the receiver/transmitter component 206 can receive 1×/DO and data over antenna 304, as described, via receive path 708.

For example, 1×/DO can be transmitted and received over antenna 302 to facilitate active mode communication, as well as received over antenna 304 for diversity. Data can be simultaneously received over antenna 302 and/or shared received over antenna 304 in a different time period. The receiver/transmitter component 206 can forward signals to the multimode communication component 210, as described, using the appropriate receive path. In another example, GPS can be received over antenna 302 using receive path 704 while data is simultaneously received over receive path 706 and/or 708. Many other combinations are possible as well in this partial simultaneous/partial shared receiving configuration.

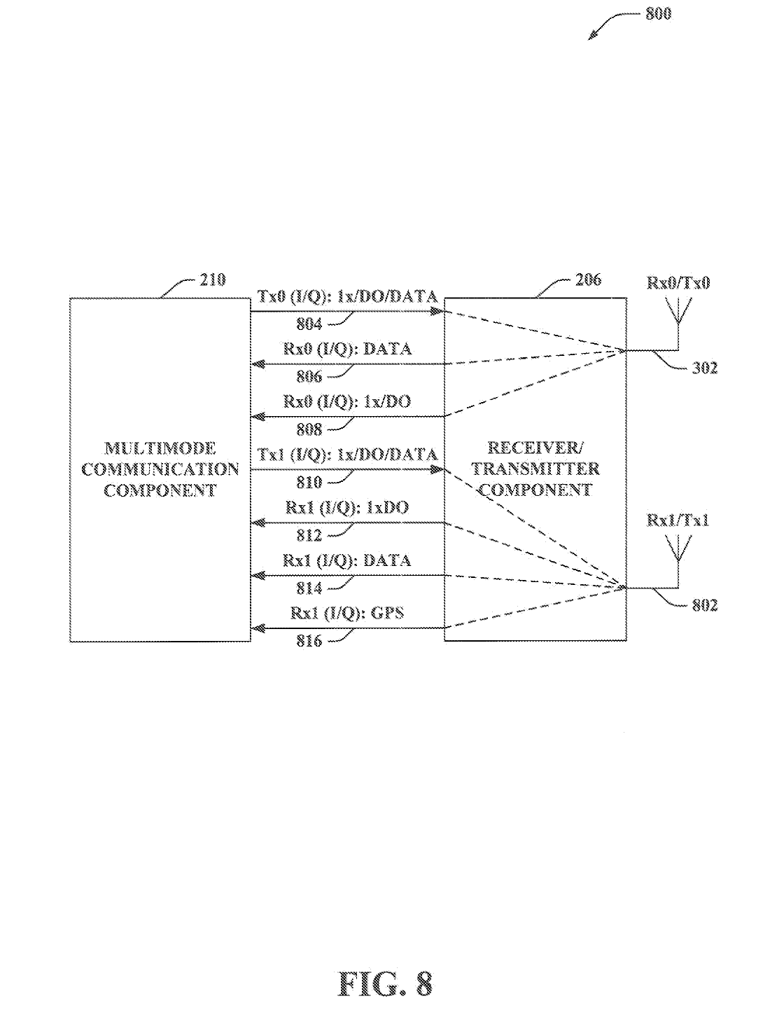

Referring to FIG. 8, illustrated is an example system 800 that supports simultaneously receiving and transmitting signals related to disparate communication technologies in a wireless network. The system 800 includes a receiver/transmitter component 206 that implements a plurality of receiving and transmitting paths to a multimode communication component 210. In addition, the system 800 includes a receive/transmit antenna 302 and another receive/transmit antenna 802 to facilitate concurrent communication, as described. As shown, the multimode communication component 210 can leverage the receiver/transmitter component 206 to transmit 1×, DO, and/or data (e.g., LTE, UMB, UMTS, etc.) over antenna 302 using transmit path 804. Sharing antenna 302 to transmit different technologies can be accomplished in a time domain such that each technology is scheduled to transmit in a different time period. Similarly, the multimode communication component 210 can leverage the receiver/transmitter component 206 to transmit 1×, DO, and/or data (e.g., LTE, UMB, UMTS, etc.) over antenna 802 using transmit path 810. Thus, simultaneous transmission over the two antennas 302 and 802 is provided, though at each antenna, shared transmitting is implemented.

Additionally, five receive paths are shown between the multimode communication component 210 and receiver/transmitter 204 to simultaneously receive signals of each of the disparate communication technologies. For example, a receive path 806 is shown for a data signal over antenna 302, where the data signal can be LTE, UMB, UMTS, and/or the like, as well as a receive path 808 for 1×/DO (or other cell data) over antenna 302. Thus, data and 1×/DO can be simultaneously received over the antenna 302 and separated by the receiver/transmitter component 206 (e.g., using a duplexer or other splitting device), for forwarding to the multimode communication component 210. Similarly, receive paths 812, 814, and 816 are shown for respectively receiving 1×/DO, data, and GPS signals simultaneously over antenna 802. The receiver/transmitter component 206 can separate the signals using a triplexer, in one example, or similar device, for forwarding to the multimode communication component 210, as described. In this regard, there are many receiving/transmitting modes available in this configuration.

For example, 1×/DO can be transmitted and received over antenna 302 to facilitate active mode communication, as well as received over antenna 802 for diversity. Simultaneously, for example, receiver/transmitter component 206 can transmit or receive data over antenna 802, to support active mode communication, as well as receive data over antenna 302. Various multiplexing components in the receiver/transmitter components 204, as described, can separate the signals for forwarding to the multimode communication component 210. Many other combinations are possible as well in this full simultaneous receiving configuration. In another example, related to this and previous figures, multiple receiver/transmitter components 206 can be utilized to implement transmit and receive paths. For example, one receiver/transmitter component 206 can be connected to antenna 302 handling transmit path 804 along with receive paths 806 and 808. Another receiver/transmitter component (not shown) can be connected to antenna 802 handling transmit path 810 and receive paths 812, 814, and 816, for example.

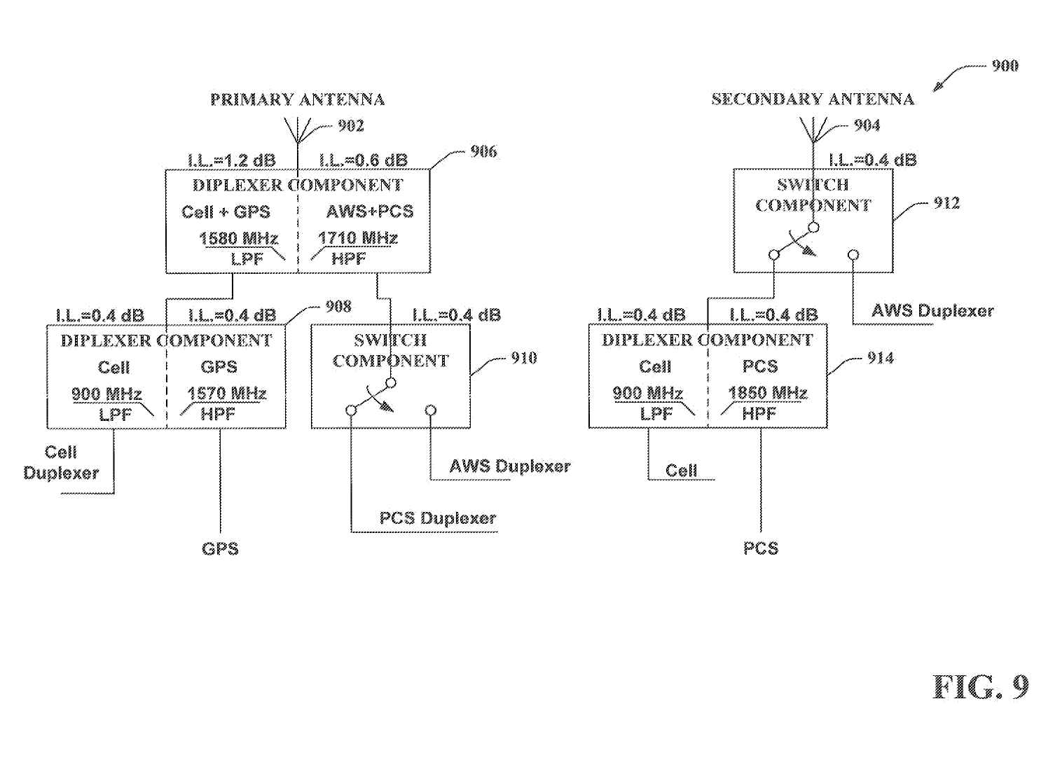

Turning now to FIG. 9, example antenna configurations 900 are depicted to facilitate concurrently receiving signals of disparate communication technologies, as described herein. The configurations 900 show a primary antenna 902 and secondary antenna 904 of a wireless device. In this example, the primary antenna 902 can receive communications over multiple bands. For example, the primary antenna 902 can receive over cell, GPS, advanced wireless service (AWS), and personal communication service (PCS) bands. A diplexer component 906 can separate cell and GPS band signals from AWS and PCS band signals by frequency so that each can be simultaneously received, as described. Similarly, a diplexer component 908 can separate cell band signals from GPS band signals by frequency. In addition, a switch component 910 can be utilized to implement shared receiving for AWS and PCS. In this regard, AWS and PCS can be received over different periods of time depending on when the switch component 910 is switched on the respective technology. Moreover, it is to be appreciated that AWS and PCS can communicate data signals, such as LTE, UMB, UTMS, etc., and the cell bands can be used to carry voice.

Moreover, secondary antenna 904 can receive cell, PCS, and AWS bands. As shown, a switch component 912 can separate cell and PCS bands from AWS bands to facilitate shared receiving, as described herein. In addition, the cell and PCS bands can be separated using diplexer component 914, which facilitates simultaneously receiving the signals. Thus, for example, secondary antenna 904 can receive cell and PCS signals simultaneously while receiving AWS in different time periods. In addition, for example, the primary antenna 902 should not receive 1×/DO over a PCS band while receiving data over the AWS band (since this would require switching); rather, using a cell band for 1×/DO allows for simultaneous receipt, in one example.

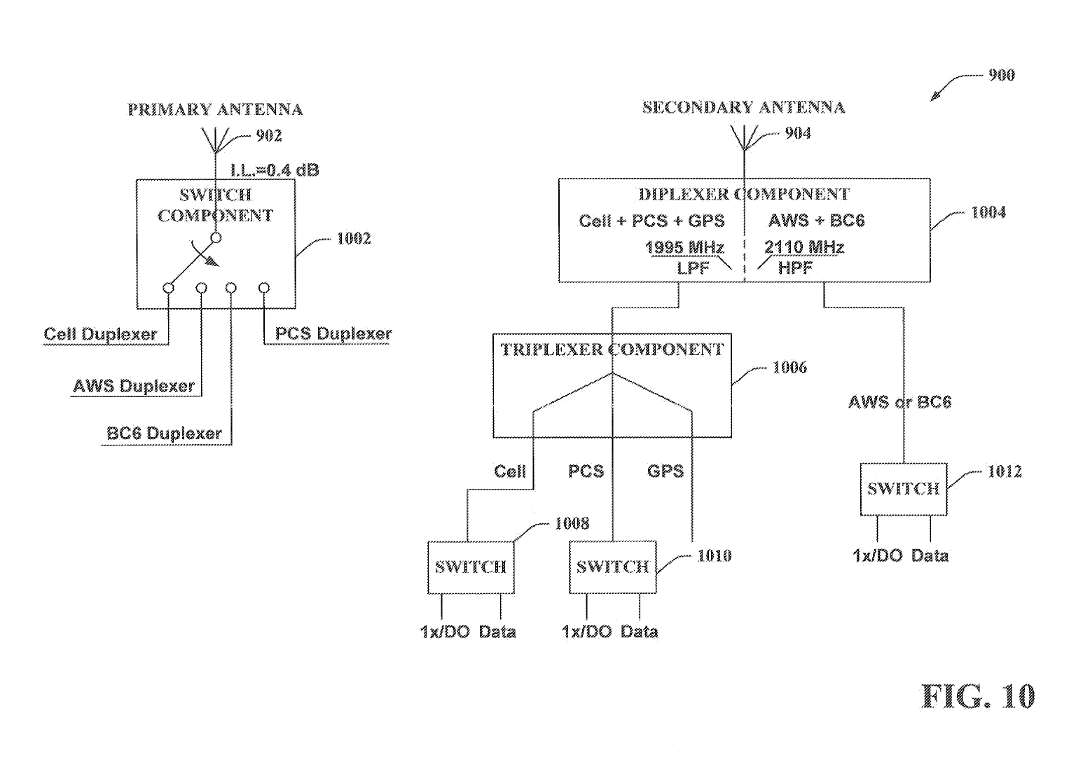

Referring to FIG. 10, illustrated are example antenna configurations 1000 to facilitate concurrently receiving signals of disparate communication technologies, as described herein. The configurations 1000 show a primary antenna 902 and secondary antenna 904 of a wireless device. In this example, the primary antenna 902 can receive communications over multiple bands. For example, the primary antenna 902 can receive over cell, AWS, PCS, and BC6 bands. A switch component 1002 can implement shared receiving for cell, AWS, BC6, and PCS technology such that the technologies can be received in disparate time periods. The secondary antenna 904 can receive over cell, AWS, PCS, BC6, and GPS bands. A diplexer component 1004 is provided that can separate cell, PCS, and GPS bands from AWS and BC6 bands by frequency. Similarly, a triplexer component 1006 separates cell bands from PCS bands and GPS bands. Switches 1008 and 1010 can be employed to separate 1×/DO and data from cell band and from PCS band. In addition, a switch 1012 is utilized to separate 1×/DO from data in the AWS or BC6 band. The above examples are but two example antenna configurations; it is to be appreciated that substantially limitless configurations are possible.

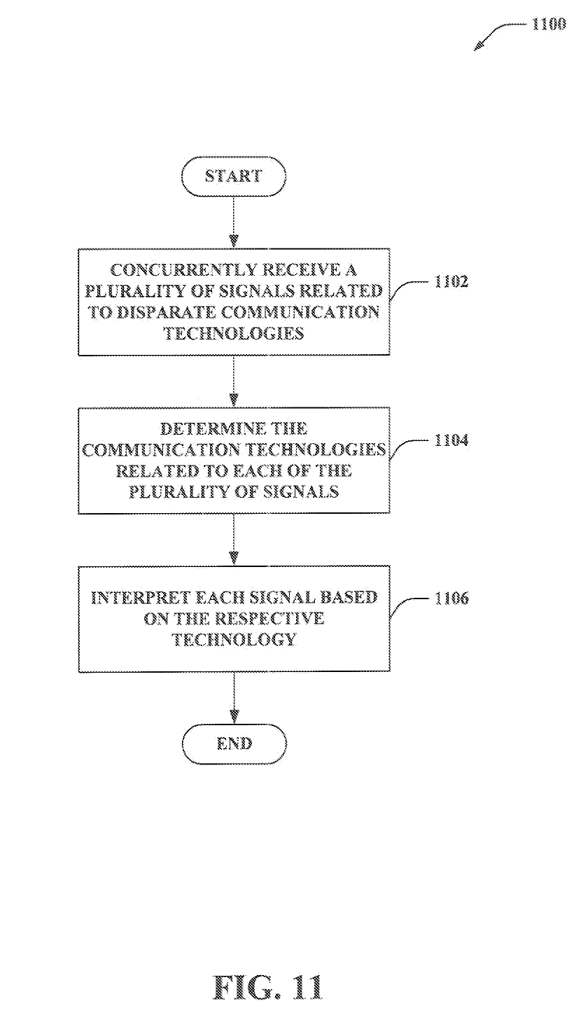

Referring to FIG. 11, a methodology relating to facilitating multimode communication in wireless networks is illustrated. While, for purposes of simplicity of explanation, the methodology is shown and described as a series of acts, it is to be understood and appreciated that the methodology is not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 11, a methodology 1100 that facilitates communicating in multiple modes over a wireless network is shown. At 1102, a plurality of signals related to disparate communication technologies are concurrently received. As described, concurrently receiving can refer to simultaneous and/or shared receiving. At 1104, communication technologies related to each of the plurality of signals can be determined. For example, where signals are simultaneously received, the technology can relate to a multiplexer filter over which the signal is obtained; where shared receiving is implemented, the technology can relate to an active switch of an antenna switching mechanism. At 1106, each signal can be interpreted based on the determined technology to facilitate multimode communications.

It will be appreciated that, in accordance with one or more aspects described herein, inferences can be made regarding antenna switching, determining signal technologies, and/or the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

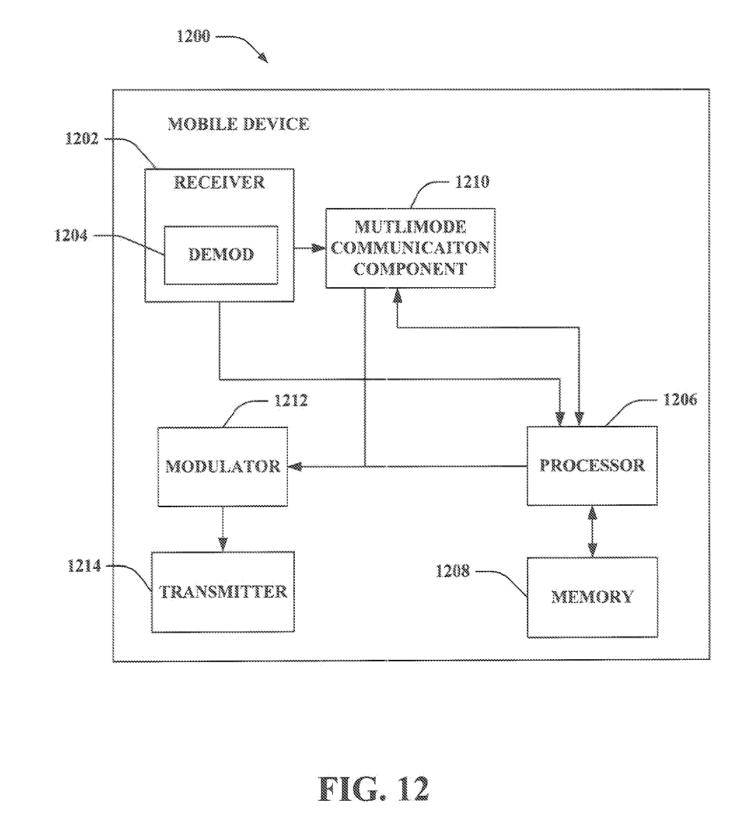

FIG. 12 is an illustration of a mobile device 1200 that facilitates multimode communication, as described herein. Mobile device 1200 comprises a receiver 1202 that receives one or more signals over one or more carriers from, for instance, a receive antenna (not shown), performs typical actions on (e.g., filters, amplifies, downconverts, etc.) the received signals, and digitizes the conditioned signals to obtain samples. Receiver 1202 can comprise a demodulator 1204 that can demodulate received symbols and provide them to a processor 1206 for channel estimation. Processor 1206 can be a processor dedicated to analyzing information received by receiver 1202 and/or generating information for transmission by a transmitter 1214, a processor that controls one or more components of mobile device 1200, and/or a processor that both analyzes information received by receiver 1202, generates information for transmission by transmitter 1214, and controls one or more components of mobile device 1200.

Mobile device 1200 can additionally comprise memory 1208 that is operatively coupled to processor 1206 and that can store data to be transmitted, received data, information related to available channels, data associated with analyzed signal and/or interference strength, information related to an assigned channel, power, rate, or the like, and any other suitable information for estimating a channel and communicating via the channel. Memory 1208 can additionally store protocols and/or algorithms associated with estimating and/or utilizing a channel (e.g., performance based, capacity based, etc.).

It will be appreciated that the data store (e.g., memory 1208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1208 of the subject systems and methods is intended to comprise, without being limited to, these and any other suitable types of memory.

Moreover, the receiver 1202 can concurrently receive communications related to disparate technologies, such as voice, data, and/or GPS, using simultaneous or shared receiving. In this regard, the receiver 1202 can configure multiple receive paths as described in previous figures. The receiver 1202 can communicate concurrently received signals to a multimode communication component 1210, as described herein. The mobile device also comprises a transmitter 1214 that transmits signals to, for instance, a base station, another mobile device, etc. Although depicted as being separate from the processor 1206, it is to be appreciated that the demodulator 1204, multimode communication component 1210, and/or modulator 1212 can be part of the processor 1206 or multiple processors (not shown).

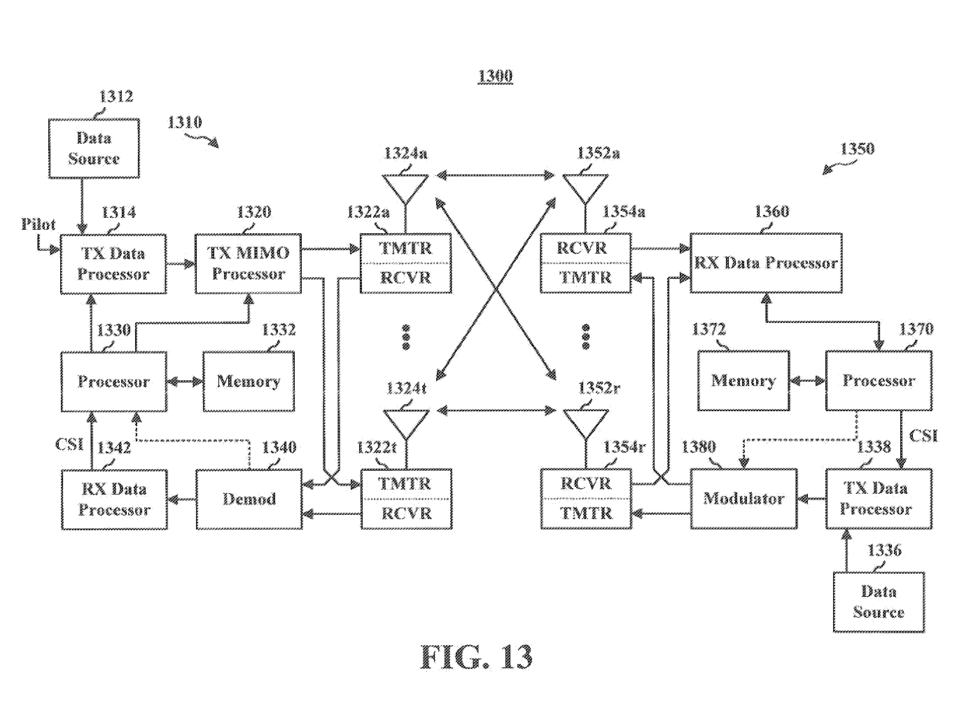

FIG. 13 shows an example wireless communication system 1300. The wireless communication system 1300 depicts one base station 1310 and one mobile device 1350 for sake of brevity. However, it is to be appreciated that system 1300 can include more than one base station and/or more than one mobile device, wherein additional base stations and/or mobile devices can be substantially similar or different from example base station 1310 and mobile device 1350 described below. In addition, it is to be appreciated that base station 1310 and/or mobile device 1350 can employ the systems (FIGS. 1-10 and 12) and/or methods (FIG. 11) described herein to facilitate wireless communication there between.

At base station 1310, traffic data for a number of data streams is provided from a data source 1312 to a transmit (TX) data processor 1314. According to an example, each data stream can be transmitted over a respective antenna. TX data processor 1314 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1350 to estimate channel response. The multiplexed pilot and coded data for each data stream can be modulated (e.g., symbol mapped) based on a particular modulation scheme (e.g., BPSK, QPSK, M-PSK, M-quadrature amplitude modulation (M-QAM), etc.) selected for that data stream to provide modulation symbols. The data rate, coding, and modulation for each data stream can be determined by instructions performed or provided by processor 1330.

The modulation symbols for the data streams can be provided to a TX MIMO processor 1320, which can further process the modulation symbols (e.g., for OFDM). TX MIMO processor 1320 then provides N_{T} modulation symbol streams to N_{T} transmitters (TMTR) 1322a through 1322t. In various embodiments, TX MIMO processor 1320 applies beamforming weights to the symbols of the data streams and to the antenna from which the symbol is being transmitted.

Each transmitter 1322 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1322a through 1322t are transmitted from N_{T} antennas 1324a through 1324t, respectively.

At mobile device 1350, the transmitted modulated signals are received by N_{R} antennas 1352a through 1352r and the received signal from each antenna 1352 is provided to a respective receiver (RCVR) 1354a through 1354r. Each receiver 1354 conditions (e.g., filters, amplifies, and downconverts) a respective signal, digitizes the conditioned signal to provide samples, and further processes the samples to provide a corresponding “received” symbol stream.

An RX data processor 1360 can receive and process the N_{R} received symbol streams from N_{R} receivers 1354 based on a particular receiver processing technique to provide N_{T} “detected” symbol streams. RX data processor 1360 can demodulate, deinterleave, and decode each detected symbol stream to recover the traffic data for the data stream. The processing by RX data processor 1360 is complementary to that performed by TX MIMO processor 1320 and TX data processor 1314 at base station 1310.

A processor 1370 can periodically determine which precoding matrix to utilize as discussed above. Further, processor 1370 can formulate a reverse link message comprising a matrix index portion and a rank value portion.

The reverse link message can comprise various types of information regarding the communication link and/or the received data stream. The reverse link message can be processed by a TX data processor 1338, which also receives traffic data for a number of data streams from a data source 1336, modulated by a modulator 1380, conditioned by transmitters 1354a through 1354r, and transmitted back to base station 1310.

At base station 1310, the modulated signals from mobile device 1350 are received by antennas 1324, conditioned by receivers 1322, demodulated by a demodulator 1340, and processed by a RX data processor 1342 to extract the reverse link message transmitted by mobile device 1350. Further, processor 1330 can process the extracted message to determine which precoding matrix to use for determining the beamforming weights.

Processors 1330 and 1370 can direct (e.g., control, coordinate, manage, etc.) operation at base station 1310 and mobile device 1350, respectively. Respective processors 1330 and 1370 can be associated with memory 1332 and 1372 that store program codes and data. Processors 1330 and 1370 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

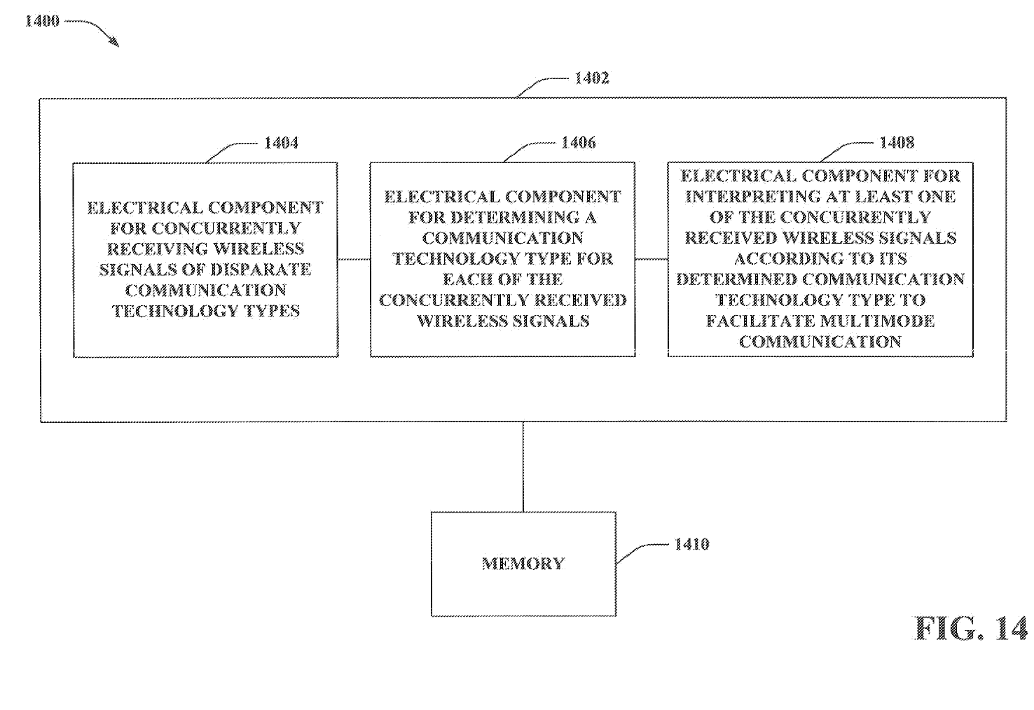

With reference to FIG. 14, illustrated is a system 1400 that facilitates multimode communication, as described herein. For example, system 1400 can reside at least partially within a base station, mobile device, etc. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For instance, logical grouping 1402 can include an electrical component for concurrently receiving wireless signals of disparate communication technology types 1404. As described, the technology types can relate to voice, data, or GPS and can be received over cell, AWS, PCS, BC6, GPS, or similar bands, for example. In addition, concurrent receipt of signals can refer to simultaneous and/or shared receipt, as described above. Further, logical grouping 1402 can comprise an electrical component for determining a communication technology type for each of the concurrently received wireless signals 1406. This can be determined based at least in part on frequency over which the signal is received, an active switch for a switching antenna, and/or the like, as described.

Furthermore, logical grouping 1402 can include an electrical component for interpreting at least one of the concurrently received wireless signals according to its determined communication technology type to facilitate multimode communication 1408. Thus, for example, upon concurrently receiving signals and determining respective communication technologies, the signals can be processed. Additionally, system 1400 can include a memory 1410 that retains instructions for executing functions associated with electrical components 1404, 1406 and 1408. While shown as being external to memory 1410, it is to be understood that one or more of electrical components 1404, 1406, and 1408 can exist within memory 1410.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What is claimed is:

1. A method for supporting multimode communication in wireless networks, comprising:
concurrently receiving a plurality of signals from one or more wireless devices, wherein each signal in the plurality of signals is of a disparate communication technology including a voice, a data or a global positioning system (GPS) technology;
determining the communication technology related to each signal in the plurality of signals; and
interpreting each signal in the plurality of signals to facilitate multimode communication.

2. The method of claim 1, wherein concurrently receiving the plurality of signals includes simultaneously receiving each of a portion of the plurality of signals in a single signal over an antenna.

3. The method of claim 2, wherein determining the communication technology related to each signal in the plurality of signals includes demultiplexing each of the portion of the plurality of signals from the single signal.

4. The method of claim 1, wherein concurrently receiving the plurality of signals includes receiving each of a portion of the plurality of signals in a different time period over a switched antenna.

5. The method of claim 4, wherein determining the communication technology related to each signal in the plurality of signals includes determining an active switch of the switched antenna.

6. The method of claim 1, wherein the data technology is third generation partnership project (3GPP) long term evolution (LTE).

7. The method of claim 1, wherein voice technology is 1× radio transmission technology.

8. The method of claim 1, wherein at least one signal of the plurality of signals is of GPS technology and is received over an antenna and at least one disparate signal of the plurality of signals is of a data technology and is simultaneously received over the antenna.

9. The method of claim 8, wherein another signal of the plurality of signals is of the data technology and is simultaneously received over a disparate antenna to facilitate diversity mode communication for the data technology.

10. A wireless communications apparatus, comprising:
at least one processor configured to:
determine a plurality communication technologies related to a plurality of concurrently received signals, wherein the plurality of communication technologies relate to voice, broadband data, or global positioning system (GPS); and
interpret the plurality of signals according to the determined communications technologies to facilitate multimode communication; and
a memory coupled to the at least one processor.

11. The wireless communications apparatus of claim 10, wherein the signals are concurrently received using simultaneous or shared receiving.

12. The wireless communications apparatus of claim 10, wherein the communication technology related to broadband data is third generation partnership project (3GPP) long term evolution (LTE).

13. The wireless communications apparatus of claim 10, wherein the communication technology related to voice is 1× radio transmission technology.

14. The wireless communications apparatus of claim 10, wherein at least one signal of the plurality of concurrently received signals is of a communication technology related to GPS and is received over an antenna and at least one disparate signal of the plurality of concurrently received signals is of a communication technology related to broadband data and is simultaneously received over the antenna.

15. The wireless communications apparatus of claim 14, wherein another signal of the plurality of concurrently received signals is of the communication technology related to broadband data and is simultaneously received over a disparate antenna to facilitate diversity mode communication for the communication technology related to broadband data.

16. An apparatus that facilitates multimode communication in wireless networks, comprising:
means for concurrently receiving wireless signals of disparate communication technology types, wherein the disparate communication technology types include voice, data, or global positioning system (GPS) types;
means for determining a communication technology type for each of the concurrently received wireless signals; and
means for interpreting at least one of the concurrently received wireless signals according to its determined communication technology type to facilitate multimode communication.

17. The apparatus of claim 16, wherein the means for concurrently receiving the wireless signal simultaneously receives a plurality of the wireless signals in a single signal over an antenna.

18. The apparatus of claim 17, wherein the means for determining the communication technology type demultiplexes the plurality of the wireless signals from the single signal.

19. The apparatus of claim 16, wherein the means for concurrently receiving the wireless signals receives a plurality of the wireless signals in a different time period over a switched antenna.

20. The apparatus of claim 19, wherein the means for determining the communication technology related to the plurality of signals includes determining an active switch of the switched antenna.

21. The apparatus of claim 16, wherein the data type is third generation partnership project (3GPP) long term evolution (LTE).

22. The apparatus of claim 16, wherein voice type is 1× radio transmission technology.

23. The apparatus of claim 16, wherein at least one of the wireless signals is of GPS type, at least one disparate signal of the wireless signals is of a data type, and the means for concurrently receiving the wireless signals simultaneously receives the GPS and data type signals over one of a plurality of antennas.

24. The apparatus of claim 23, wherein a third signal of the wireless signals is of the data type and the means for concurrently receiving the wireless signals simultaneously receives the third signal over a disparate antenna in the plurality of antennas to facilitate diversity mode communication for the data type.

25. A computer program product, comprising:
a computer-readable medium comprising:
code for causing at least one computer to concurrently receive a plurality of signals from one or more wireless devices, wherein each signal in the plurality of signals is of a disparate communication technology including a voice, a data or a global positioning system (GPS) technology;
code for causing the at least one computer to determine the communication technology related to each signal in the plurality of signals; and
code for causing the at least one computer to interpret each signal in the plurality of signals to facilitate multimode communication.

26. The computer program product of claim 25, wherein concurrently receiving the plurality of signals includes simultaneously receiving each of a portion of the plurality of signals in a single signal over an antenna or receiving each of a portion of the plurality of signals in a different time period over a switched antenna.

27. The computer program product of claim 25, wherein the data technology is third generation partnership project (3GPP) long term evolution (LTE).

28. The computer program product of claim 25, wherein voice technology is 1× radio transmission technology.

29. The computer program product of claim 25, wherein at least one signal of the plurality of signals is of GPS technology and is received over an antenna and at least one disparate signal of the plurality of signals is of a data technology and is simultaneously received over the antenna.

30. The computer program product of claim 29, wherein another signal of the plurality of signals is of the data technology and is simultaneously received over a disparate antenna to facilitate diversity mode communication for the data technology.

31. An apparatus, comprising:
a plurality of antennas that concurrently receive wireless signals of disparate communication technology types, wherein the disparate technology types include voice, data, or global positioning system (GPS) types;
a receiver/transmitter component that determines a communication technology type for each of the concurrently received wireless signals; and
a multimode communication component that interprets at least one of the concurrently received wireless signals according to its determined communication technology type to facilitate multimode communication.

32. The apparatus of claim 31, wherein one of the plurality of antennas simultaneously receives a plurality of the wireless signals in a single signal.

33. The apparatus of claim 32, wherein the receiver/transmitter component demultiplexes the plurality of the wireless signals from the single signal to determine the communication technology of each of the wireless signals.

34. The apparatus of claim 31, wherein one of the plurality of antennas receives a plurality of the wireless signals in a different time period using an antenna switch.

35. The apparatus of claim 34, wherein the receiver/transmitter component determines the communication technology based at least in part on an active switch of the antenna switch.

36. The apparatus of claim 31, wherein the data type is third generation partnership project (3GPP) long term evolution (LTE).

37. The apparatus of claim 31, wherein voice type is 1× radio transmission technology.

38. The apparatus of claim 31, wherein at least one of the wireless signals is of GPS type, at least one disparate signal of the wireless signals is of a data type, and an antenna in the plurality of antennas simultaneously receives the GPS and data type signals.

39. The apparatus of claim 38, wherein a third signal of the wireless signals is of the data type and a disparate antenna in the plurality of antennas simultaneously receives the third signal to facilitate diversity mode communication for the data type.
